(19) United States
(12) Patent Application Publication
(10) Pub. No.: US 2021/0394190 A1
(43) Pub. Date: Dec. 23, 2021

(54) INTERMITTENT DRIVING PATTERNS FOR EXTENDED HOLDING OF DROPLETS IN A DIGITAL MICROFLUIDIC DEVICE

(71) Applicant: Nuclera Nucleics Ltd., Cambridge, MA (US)

(72) Inventor: Richard J. Paolini, Billerica, MA (US)

(21) Appl. No.: 17/353,031

(22) Filed: Jun. 21, 2021

Related U.S. Application Data
(60) Provisional application No. 63/041,195, filed on Jun. 19, 2020.

(51) Int. Cl. B01L 3/00

(52) U.S. Cl. CPC B01L 3/502792; B01L 2300/161; B01L 2400/0427

(57) ABSTRACT

A method for holding an aqueous droplet in a selected location within a microfluidic device. The microfluidic device comprises: a top plate comprising a top substrate, a first layer of hydrophobic material applied to a surface of the top substrate, and a common top electrode between the first layer of hydrophobic material and the top substrate; a bottom plate comprising a pixel array, the pixel array comprising a plurality of pixel electrodes and a second layer of hydrophobic material applied over the plurality of pixel electrodes, and a microfluidic gap between the first and second layers of hydrophobic material. The method comprises: applying an intermittent driving pattern to pixels under the area of the droplet. The intermittent driving pattern comprises, in order: actuating a first subset of the pixels under the area of the droplet, and actuating a second subset of the pixels under the area of the droplet.

### CROSS-REFERENCE TO RELATED PATENT APPLICATIONS

This application claims priority to U.S. Provisional Application No. 63/041,195 filed on Jun. 19, 2020, the entire content of which is hereby incorporated by reference in its entirety.

### BACKGROUND

Digital microfluidic (DMF) devices use independent electrodes to propel, split, and join droplets in a confined environment, thereby providing a “lab-on-a-chip.” Digital microfluidic devices are alternatively referred to as electrowetting on dielectric, or “EWoD,” to further differentiate the method from competing microfluidic systems that rely on electrophoretic flow and/or micropumps. A 2012 review of the electrowetting technology was provided by Wheeler in “Digital Microfluidics,” Annu. Rev. Anal. Chem. 2012, 5:413-40, which is incorporated herein by reference in its entirety. The technique allows sample preparation, assays, and synthetic chemistry to be performed with tiny quantities of both samples and reagents. In recent years, controlled droplet manipulation in microfluidic cells using electrowetting has become commercially viable, and there are now products available from large life science companies, such as Oxford Nanopore.

Most of the literature reports on EWoD involve so-called “passive matrix” devices (a.k.a. “segmented” devices), whereby ten to twenty electrodes are directly driven with a controller. While segmented devices are easy to fabricate, the number of electrodes is limited by space and driving constraints. Accordingly, it is not possible to perform massive parallel assays, reactions, etc. in passive matrix devices. In comparison, “active matrix” devices (a.k.a. active matrix EWoD, a.k.a. AM-EWoD) devices can have many thousands, hundreds of thousands or even millions of addressable electrodes. The electrodes are typically switched by thin-film transistors (TFTs) and droplet motion is programmable so that AM-EWoD arrays can be used as general purpose devices that allow great freedom for controlling multiple droplets and executing simultaneous analytical processes.

DMF devices are advantageous for carrying out a large number (hundreds or thousands) of chemical or biological assays in parallel. However, the chemical and biochemical reactions that are carried out in a DMF device can take hours or even days to reach completion due to their complexity and often long incubation times. Extended exposure of a DMF array to electrical actuation in the presence of aqueous, high ionic strength reagent droplets can cause progressive electrochemical degradation of the array. In addition, droplets that are in completely unactuated regions of the DMF device tend to drift over time to unrequested places. This is problematic because the programs controlling the assays can lose track of the location of the droplets if they end up in unrequested locations. To combat this type of drifting, the DMF devices continuously actuate the drops in static locations to keep them in place.

A conventional solution to maintaining the droplets in place is by applying a continuous low voltage holding force to hold the droplet in a desired location while the DMF device is in use. Using a continuous low addressing voltage requires constant actuation and will be dependent on the dielectric used. The use of constant actuation, however, may be disadvantageous because over time the constant voltage may degrade the DMF device or a biological sample present in the droplet. It is also energy inefficient to constantly apply voltage to a droplet when an operation is not being performed on the sample. Thus, there is a need for an improved EWoD device capable of temporarily pinning a droplet in a desired location on the array that does not require a constant application of voltage.

For some aqueous reagents of high ionic strength, repeated actuation of the pixel electrodes causes progressive degradation of the performance of the device. The degradation is usually related to the total impulse (voltage applied multiplied by pulse time) that has been applied to a pixel in the presence of a droplet, so constant actuation of the droplet in a static location can quickly consume the usable lifetime of the pixels that the droplet occupies for very little benefit, since the drop is not being moved or split but instead simply being held in place.

### SUMMARY OF INVENTION

In a first example, the present application addresses the shortcomings of the prior art by disclosing a method for holding an aqueous droplet in a selected location within a digital microfluidic device. The microfluidic device comprises: a top plate comprising a top substrate, a first layer of hydrophobic material applied to a surface of the top substrate, and a common top electrode between the first layer of hydrophobic material and the top substrate; a bottom plate comprising a pixel array, the pixel array comprising a plurality of pixel electrodes and a second layer of hydrophobic material applied over the plurality of pixel electrodes, and a microfluidic gap between the first and second layers of hydrophobic material. The method comprises: applying an intermittent driving pattern to pixels under the area of the droplet. The intermittent driving pattern comprises, in order: actuating a first subset of the pixels under the area of the droplet, and actuating a second subset of the pixels under the area of the droplet.

In a second example, the present application discloses a novel digital microfluidic device, comprising: a top plate comprising a top substrate, a first layer of hydrophobic material applied to a surface of the top substrate, and a common top electrode between the first layer of hydrophobic material and the top substrate; a bottom plate comprising a pixel array, the pixel array comprising a plurality of pixel electrodes and a second layer of hydrophobic material applied over the plurality of pixel electrodes, a processing unit operably programmed to perform a microfluidic driving method; and a controller operatively coupled to the processing unit, common top electrode, and a bottom plate pixel array, wherein the controller is configured to provide actuation voltages between the common top electrode and the pixel electrodes. The processing unit is operably programmed to: receive input instructions, the input instructions relating to a droplet operation; select an intermittent driving pattern for holding in place a droplet of the droplet operation. The intermittent driving pattern comprises, in order: actuating a first subset of pixels under the area of the droplet, and actuating a second subset of the pixels under the area of the droplet; and outputting electrode actuation instructions to the controller, the electrode actuation instructions relating to a driving sequence for implementing the intermittent driving pattern, to hold the droplet in a selected location.

### BRIEF DESCRIPTION OF DRAWINGS

FIG. 1 shows a conventional microfluidic device including a common top electrode.

FIG. 2A is a schematic diagram of a TFT architecture for a plurality of propulsion electrodes of an EWoD device.

FIG. 2B is a diagrammatic view of an exemplary driving system for controlling droplet operation by an AM-EWoD propulsion electrode array.

FIG. 3 is a schematic diagram of a portion of a bottom plate TFT array, including a propulsion electrode, a thin film transistor, a storage capacitor, a dielectric layer, and a hydrophobic layer.

FIG. 4 is a schematic top view illustration of a droplet spanning an area of 10×10 pixels on array. A subset of pixels under the area of the droplet is actuated.

FIG. 5 is a schematic top view illustration of a number of pixel subsets actuated in the course of an intermittent driving pattern under the droplet of FIG. 4.

FIG. 6 is a flow chart illustrating an example process for selecting and implementing intermittent driving patterns.

FIG. 7 is a schematic illustration of pixel subset patterns (Patterns 1-5) at three locations.

FIG. 8 shows the motion of droplets using the various pixel actuation patterns in FIG. 7.

### DEFINITIONS

Unless otherwise noted, the following terms have the meanings indicated.

“Actuate” with reference to one or more electrodes means effecting a change in the electrical state of the one or more electrodes which, in the presence of a droplet, results in a manipulation of the droplet.

“Droplet” means a volume of liquid that electrowets a hydrophobic surface and is at least partially bounded by carrier fluid. For example, a droplet may be completely surrounded by carrier fluid or may be bounded by carrier fluid and one or more surfaces of an EWoD device. Droplets may take a wide variety of shapes; non-limiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more working surface of an EWoD device. Droplets may include typical polar fluids such as water, as is the case for aqueous or non-aqueous compositions, or may be mixtures or emulsions including aqueous and non-aqueous components. The specific composition of a droplet is of no particular relevance, provided that it electrowets a hydrophobic working surface. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include one or more reagent, such as water, deionized water, saline solutions, acidic solutions, basic solutions, detergent solutions and/or buffers. Other examples of droplet contents include reagents, such as a reagent for a biochemical protocol, a nucleic acid amplification protocol, an affinity-based assay protocol, an enzymatic assay protocol, a gene sequencing protocol, a protein sequencing protocol, and/or a protocol for analyses of biological fluids. Further example of reagents include those used in biochemical synthetic methods, such as a reagent for synthesizing oligonucleotides finding applications in molecular biology and medicine, and/or one more nucleic acid molecules. The oligonucleotides may contain natural or chemically modified bases and are most commonly used as antisense oligonucleotides, small interfering therapeutic RNAs (siRNA) and their bioactive conjugates, primers for DNA sequencing and amplification, probes for detecting complementary DNA or RNA via molecular hybridization, tools for the targeted introduction of mutations and restriction sites in the context of technologies for gene editing such as CRISPR-Cas9, and for the synthesis of artificial genes by “synthesizing and stitching together” DNA fragments.

“Droplet operation” means any manipulation of one or more droplets on a microfluidic device. A droplet operation may, for example, include: loading a droplet into the microfluidic device; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a microfluidic device; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles.

“Gate driver” is a power amplifier that accepts a low-power input from a controller, for instance a microcontroller integrated circuit (IC), and produces a high-current drive input for the gate of a high-power transistor such as a TFT. “Source driver” is a power amplifier producing a high-current drive input for the source of a high-power transistor.

“Moiety” is defined as a portion of a complete structure of a molecule, the portion including at least 2 atoms joined together in a particular way. The term “moiety” includes functional groups and/or discreet bonded residues that are present in a molecule that is covalently bound or absorbed to a surface.

“Hydrophilic moiety” and “hydrophobic moiety” is each defined as a moiety capable of forming a hydrophilic or a hydrophobic molecule, respectively. In other words, if a molecule containing exclusively a hydrophilic moiety were synthesized, the molecule would be hydrophilic; if a molecule containing exclusively a hydrophobic moiety were synthesized, the molecule would be hydrophobic.

“Nucleic acid molecule” is the overall name for DNA or RNA, either single- or double-stranded, sense or antisense. Such molecules are composed of nucleotides, which are the monomers made of three moieties: a 5-carbon sugar, a phosphate group and a nitrogenous base. If the sugar is a ribosyl, the polymer is RNA (ribonucleic acid); if the sugar is derived from ribose as deoxyribose, the polymer is DNA (deoxyribonucleic acid). Nucleic acid molecules vary in length, ranging from oligonucleotides of about 10 to 25 nucleotides which are commonly used in genetic testing, research, and forensics, to relatively long or very long prokaryotic and eukaryotic genes having sequences in the order of 1,000, 10,000 nucleotides or more. Their nucleotide residues may either be all naturally occurring or at least in part chemically modified, for example to slow down in vivo degradation. Modifications may be made to the molecule backbone, e.g. by introducing nucleoside organothiophosphate (PS) nucleotide residues. Another modification that is useful for medical applications of nucleic acid molecules is 2′ sugar modifications. Modifying the 2′ position sugar is believed to increase the effectiveness of therapeutic oligonucleotides by enhancing their target binding capabilities, specifically in antisense oligonucleotides therapies. Two of the most commonly used modifications are 2′-O-methyl and the 2′-Fluoro.

When a liquid in any form (e.g., a droplet or a continuous body, whether moving or stationary) is described as being “on”, “at”, or “over an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a microfluidic device, it should be understood that the droplet is arranged on the device in a manner which facilitates using the device to conduct one or more droplet operations on the droplet, the droplet is arranged on the device in a manner which facilitates sensing of a property of or a signal from the droplet, and/or the droplet has been subjected to a droplet operation on the droplet actuator.

“Each,” when used in reference to a plurality of items, is intended to identify an individual item in the collection but does not necessarily refer to every item in the collection. Exceptions can occur if explicit disclosure or context clearly dictates otherwise.

When one part of a given object or assembly is described as “covering” or “applied over” another part, it should be understood that the two parts need not necessarily be in direct physical contact. Rather, one or more additional parts may be positioned in between the first and second parts, depending on the context. For example, in devices where a hydrophobic layer covers an electrode, one or more additional layers, for example a dielectric, may be interposed between the two.

The use of “top” and “bottom” is merely a convention as the locations of the plates in a DMF device can be switched, and the devices can be oriented in a variety of ways, for example, the top and bottom plates can be roughly parallel while the overall device is oriented so that the plates are normal to a work surface (as opposed to parallel to the work surface as shown in the figures).

### DETAILED DESCRIPTION

The present application relates to methods and structures for holding droplets in place in DMF devices. In one example, a droplet is held in a desired location by intermittently pulsing the pixel(s) under its area, just as the drop would start to move, then wait as long as possible between intermittent pulses to keep the drop in place. This approach eliminates or at least reduces wear caused to the DMF by conventional methods for maintaining droplets in place by applying a continuous low voltage. To further reduce damage, this application further relates to driving patterns whereby subsets of the pixels under a droplet are intermittently addressed. In a first pulse, a first subset of the pixels under the area of the droplet are driven to hold the droplet in a selected location and prevent drift. In a second pulse, a second subset of the pixels under the area of the droplet are actuated. An intermittent driving pattern may include any number of subsequent pulses, each pulse addressing a different subset of the pixels under the droplet. Once the pattern has reached completion, one or more additional cycles may be implemented until the droplet is ready to move to another position on the pixel array or undergo other types of manipulations.

Each pixel subset differs from that actuated in the previous pulse by at least one pixel. In other words, at least one of the pixels driven in one pulse is not actuated in the subsequent pulse following directly thereafter. However, embodiments where more or even all of the pixels actuated in one pulse are left unactuated in the following pulse(s) are also within the scope of the present disclosure. By relying on this intermittent driving strategy, the total actuation time for each electrode is kept at a minimum. As a result, electrode degradation associated with long driving sequences is eliminated or at least minimized in instances where droplets are kept in place for extended durations of time. This increases the usable lifespan of a DMF device while diminishing downtimes and maintenance expenses, and is especially applicable to devices of high resolution where droplets are typically much larger than individual pixels.

In an example embodiment, the bottom plate of the device includes an active electrowetting on dielectric (AM-EWoD) array featuring a plurality of pixel elements, each pixel including a propulsion electrode. The AM-EWoD matrix may be in the form of a transistor active matrix backplane, for example, a thin film transistor (TFT) backplane where each propulsion electrode is operably attached to a transistor and capacitor actively maintaining the electrode state while the electrodes of other array elements are being addressed. The common top electrode may be driven by its own separate circuitry.

A pixel voltage is defined by a voltage difference between a pixel electrode and the common top electrode. By adjusting the frequency and amplitude of the signals driving the pixel electrodes and top electrode, the voltage of each pixel in the array may be controlled to operate the AM-EWoD device at different modes of operation in accordance with different droplet manipulation operations to be performed. In some embodiments, the TFT array may be implemented with amorphous silicon (a-Si), thereby reducing the cost of production to the point that the device can be disposable.

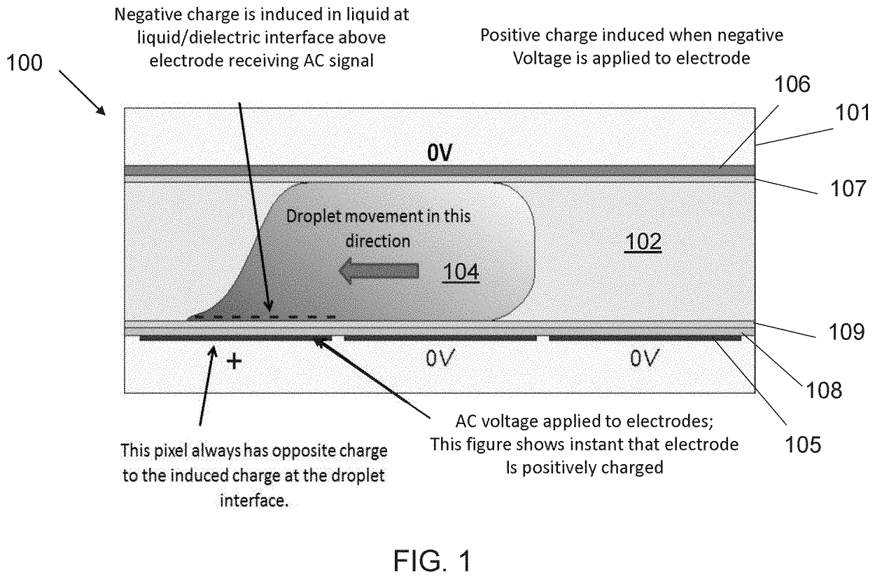

The fundamental operation of a conventional EWoD device is illustrated in the sectional image of FIG. 1. The EWoD 100 includes a microfluidic region filled with an oil 102 and at least one aqueous droplet 104. The microfluidic region gap depends on the size of droplets to be handled and is typically in the range 50 to 200 μm, but the gap can be larger. In a basic configuration, as shown in FIG. 1, a plurality of pixel electrodes 105 are disposed on one substrate and a single, common top electrode 106 is disposed on the opposing surface. The common top electrode 106 is often made of a transparent conductive material, for example one or more transparent conductive oxides (TCO), which are doped metal oxides used in optoelectronic devices such as flat panel displays and photovoltaics. The most common among TCOs is ITO, but other transparent conducting oxides include aluminum-doped zinc oxide (AZO), indium-doped cadmium oxide, barium stannate, strontium vanadate, and calcium vanadate. The upper surface of 106 faces top plate substrate 101. The bottom surface of 106 may be adhered to a layer of protective material, for example glass.

The device additionally includes top hydrophobic coating 107 and bottom hydrophobic coating 109 on the surfaces contacting the oil layer, as well as a dielectric layer 108 between the pixel electrodes 105 and the hydrophobic coating 109. (The upper plate may also include a dielectric layer, but it is not shown in FIG. 1). The hydrophobic layer prevents the droplet from wetting the surface. When no voltage differential is applied between adjacent electrodes, the droplet will maintain a spheroidal shape to minimize contact with the hydrophobic surfaces (oil and hydrophobic layer). Because the droplets do not wet the surface, they are less likely to contaminate the surface or interact with other droplets except when that behavior is desired.

While it is possible to have a single layer for both the dielectric and hydrophobic functions, such layers often require thick inorganic layers (to prevent pinholes) with resulting low dielectric constants, thereby requiring more than 100V for droplet movement. To achieve low voltage propulsion, it is often better to have a thin inorganic layer for high capacitance and to be pinhole free, topped by a thin organic hydrophobic layer. With this combination it is possible to have electrowetting operation with voltages in the range 10 to +/−50V, which is in the range that can be supplied by conventional TFT arrays.

Hydrophobic layers may be manufactured from hydrophobic materials formed into coatings by deposition onto a surface via suitable techniques. Depending on the hydrophobic material to be applied, example deposition techniques include spin coating, molecular vapor deposition, and chemical vapor deposition. Hydrophobic layers may be more or less wettable as usually defined by their respective contact angles. Unless otherwise specified, angles are herein measured in degrees (°) or radians (rad), according to context. For the purpose of measuring the hydrophobicity of a surface, the term “contact angle” is understood to refer to the contact angle of the surface in relation to deionized (DI) water. If water has a contact angle between 0°<θ<90°, then the surface is classed as hydrophilic, whereas a surface producing a contact angle between 90°<θ<180° is considered hydrophobic. Usually, moderate contact angles are considered to fall in the range from about 90° to about 120°, while high contact angles are typically considered to fall in the range from about 120° to about 150°. In instances where the contact angle is 150°<θ then the surface is commonly known as superhydrophobic or ultrahydrophobic. Surface wettabilities may be measured by analytical methods well known in the art, for instance by dispensing a droplet on the surface and performing contact angle measurements using a contact angle goniometer. Anisotropic hydrophobicity may be examined by tilting substrates with gradient surface wettability along the transverse axis of the pattern and examining the minimal tilting angle that can move a droplet.

Hydrophobic layers of moderate contact angle typically include one or a blend of fluoropolymers, such as PTFE (polytetrafluoroethylene), FEP (fluorinated ethylene propylene), PVF (polyvinylfluoride), PVDF (polyvinylidene fluoride), PCTFE (polychlorotrifluoroethylene), PFA (perfluoroalkoxy polymer), FEP (fluorinated ethylenepropylene), ETFE (polyethylenetetrafluoroethylene), and ECTFE (polyethylenechlorotrifluoroethylene). Commercially available fluoropolymers include Cytop® (AGC Chemicals, Exton, Pa.) and Teflon® AF (Chemours, Wilmington, Del.). An advantage of fluoropolymer films is that they can be highly inert and can remain hydrophobic even after exposure to oxidizing treatments such as corona treatment and plasma oxidation.

When a voltage differential is applied between adjacent electrodes, the voltage on one electrode attracts opposite charges in the droplet at the dielectric-to-droplet interface, and the droplet moves toward this electrode, also as illustrated in FIG. 1. The voltages needed for acceptable droplet propulsion depend on the properties of the dielectric and hydrophobic layers. AC driving is used to reduce degradation of the droplets, dielectrics, and electrodes by various electrochemistries. Operational frequencies for EWoD can be in the range 100 Hz to 1 MHz, but lower frequencies of 1 kHz or lower are preferred for use with TFTs that have limited speed of operation.

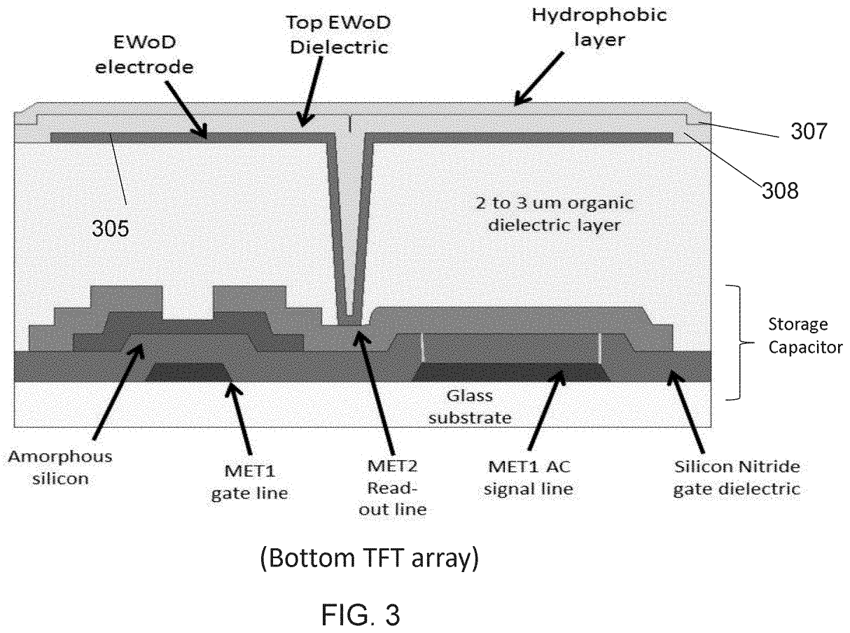

Returning to FIG. 1, the top electrode 106 is a single conducting layer normally set to zero volts or a common voltage value (V_{COM}) to take into account offset voltages on the pixel electrodes 105 due to capacitive kickback from the TFTs that are used to switch the voltage on the electrodes (see FIG. 3). The common top electrode can also have a square wave applied to increase the voltage across the liquid. Such an arrangement, also known as “top plane switching” (TPS), allows for lower propulsion voltages to be used for the TFT-connected pixel electrodes 105 because the voltage of top plate 106 is additional to the voltage supplied by the TFT.

The architecture of an amorphous silicon, TFT-switched, pixel electrode is shown in FIG. 3. The dielectric 308 must be thin enough and have a dielectric constant compatible with low voltage AC driving, such as available from conventional image controllers for LCD displays. For example, the dielectric layer may comprise a layer of approximately 20-40 nm SiO₂ over-coated with 200-400 nm plasma-deposited silicon nitride. Alternatively, the dielectric may comprise atomic-layer-deposited Al₂O₃ between 2 and 100 nm thick, preferably between 20 and 60 nm thick. The TFT may be constructed by creating alternating layers of differently-doped a-Si structures along with various electrode lines, with methods known to those of skill in the art. The hydrophobic layer 307 may be constructed from one of more of the aforementioned fluoropolymers, such as Teflon® AF and FluorPel® coatings from Cytonix (Beltsville, Md.).

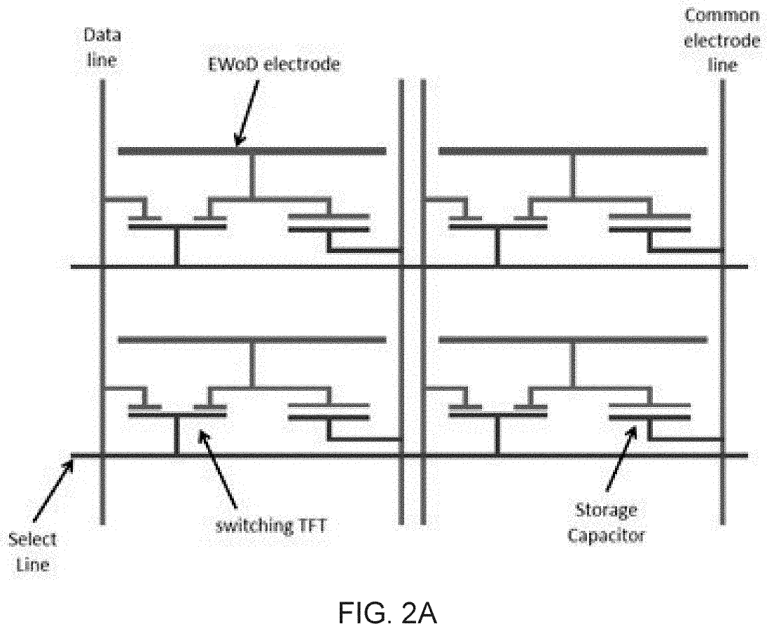

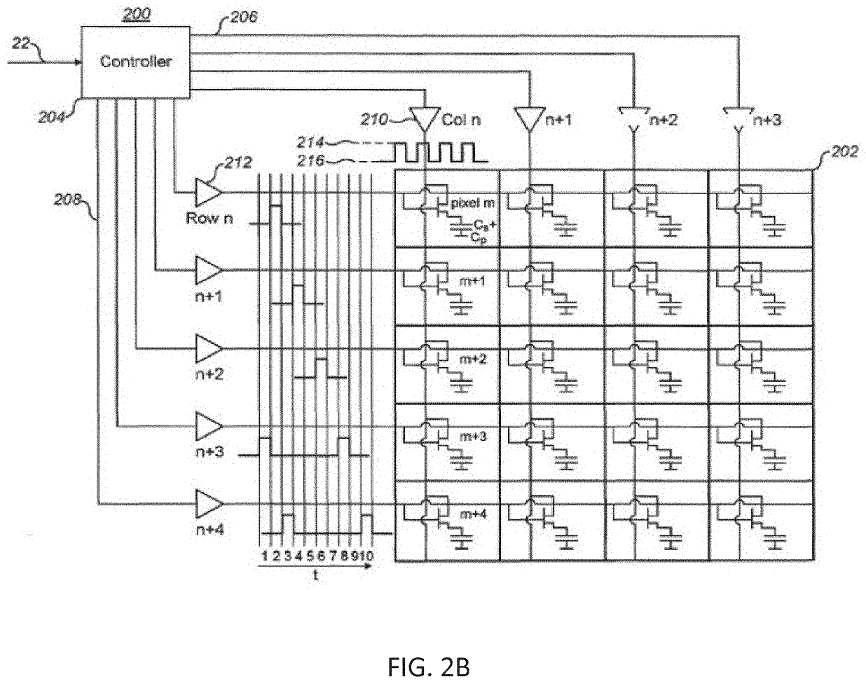

As illustrated in FIG. 2A, an active matrix of pixel electrodes can be arranged to be driven with data (source) and gate (select) lines much like an active matrix in a liquid crystal display. The gate lines are scanned for line-at-a time addressing, while the data lines carry the voltage to be transferred to propulsion electrodes for electrowetting operations. If a droplet is meant to move away from a pixel electrode, then 0 V will be applied to that (non-target) pixel electrode. If a droplet is meant to move toward a propulsion electrode, an AC voltage will be applied to that (target) pixel electrode.

FIG. 2B is a diagrammatic view of an example driving system 200 for controlling droplet operation by an AM-EWoD pixel electrode array 202. The AM-EWoD driving system 200 may be in the form of an integrated circuit adhered to a support plate. The elements of the EWoD device are arranged in the form of a matrix having a plurality of data lines and a plurality of gate lines. Each element of the matrix contains a TFT of the type illustrated in FIG. 3 for controlling the electrode potential of a corresponding electrode, and each TFT is connected to one of the gate lines and one of the data lines. The electrode of the element is indicated as a capacitor Cₚ. The storage capacitor Cₛ is arranged in parallel with Cₚ and is not separately shown in FIG. 2B.

The controller shown comprises a microcontroller 204 including control logic and switching logic. It receives input data relating to droplet operations to be performed from the input data lines 22. The microcontroller has an output for each data line of the EWoD matrix, providing a data signal. A data signal line 206 connects each output to a data line of the matrix. The microcontroller also has an output for each gate line of the matrix, providing a gate line selection signal. A gate signal line 208 connects each output to a gate line of the matrix. A data line driver 210 and a gate line driver 212 is arranged in each data and gate signal line, respectively. The figure shows the signal lines only for those data lines and gate lines shown in the figure. The gate line drivers may be integrated in a single integrated circuit. Similarly, the data line drivers may be integrated in a single integrated circuit. The integrated circuit may include the complete gate driver assembly together with the microcontroller.

The data line drivers provide the signal levels corresponding to a droplet operation. The gate line drivers provide the signals for selecting the gate line of which the electrodes are to be actuated. A sequence of voltages of one of the data line drivers 210 is shown in the Figure. As illustrated above, when there is large enough positive voltage on the gate line then there is low impedance between the data line and pixel, so the voltage on the data line is transferred to the pixel. When there is a negative voltage on the TFT gate then the TFT is high impedance and voltage is stored on the pixel capacitor and not affected by the voltage on the data line. If no movement is needed, or if a droplet is meant to move away from a pixel electrode, then 0 V will be applied to that (non-target) propulsion electrode. If a droplet is meant to move toward a pixel electrode, an AC voltage will be applied to that (target) pixel electrode. The figure shows four columns labelled n to n+3 and five rows labelled n to n+4.

As further illustrated in FIG. 2B, traditional AM-EWoD cells typically use line-at-a-time addressing, in which one gate line n is high while all the others are low. The signals on all of the data lines are then transferred to all of the pixels in row n. At the end of the line time gate line n signal goes low and the next gate line n+1 goes high, so that data for the next line is transferred to the TFT pixels in row n+1. This continues with all of the gate lines being scanned sequentially so the whole matrix is driven. This is the same method that is used in almost all AM-LCDs, such as mobile phone screens, laptop screens and LC-TVs, whereby TFTs control the voltage maintained across the liquid crystal layer, and in AM-EPDs (electrophoretic displays).

Intermittent Driving Patterns

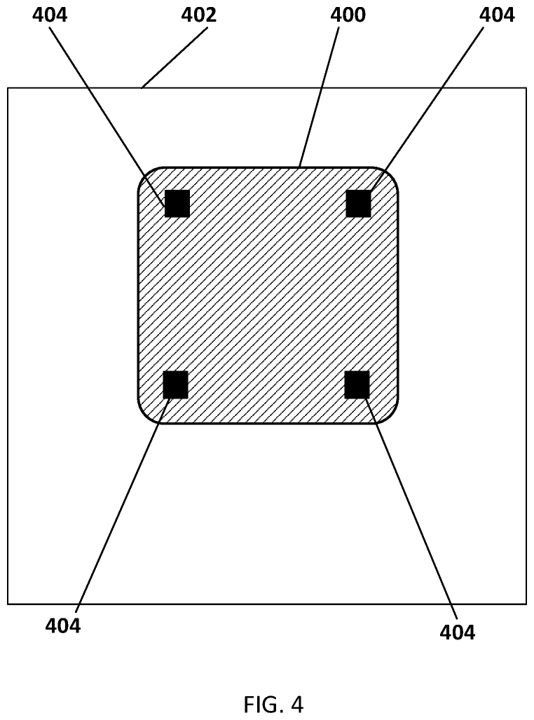

As discussed above, the present disclosure provides methods for holding a droplet in a desired location by intermittently pulsing the pixel(s) under its area. In some embodiments, the same set of pixels are actuated at every pulse. This pattern is usually applicable to low definition DMF devices, where droplets rest on a small number or even only one pixel. In another embodiment, different pulses actuate different sets of pixels. This is especially applicable to high resolution DMF devices where droplets are typically much larger than individual pixels, so that a droplet spans a relatively high number of array pixels. In one example, a TFT array may be configured with 500×500 pixel electrodes having approximately 200 micron pixel size. FIG. 4 is a schematic top view illustration of a droplet 400 spanning an area of 10×10 pixels on array 402. Each time an intermittent pulse is needed to keep the droplet in its location, a subset of pixels under the area of the droplet is actuated. It is usually advantageous if the actuated pixels are symmetrically distributed about the center point of the droplet location to the extent feasible in view of the geometry of the droplet and pixels, or at least disposed in such a way as to have their center overlap with the geometric center of the droplet location. Unless otherwise noted, the “center” of a set of pixels is herein meant to indicate the geometric center of the set.

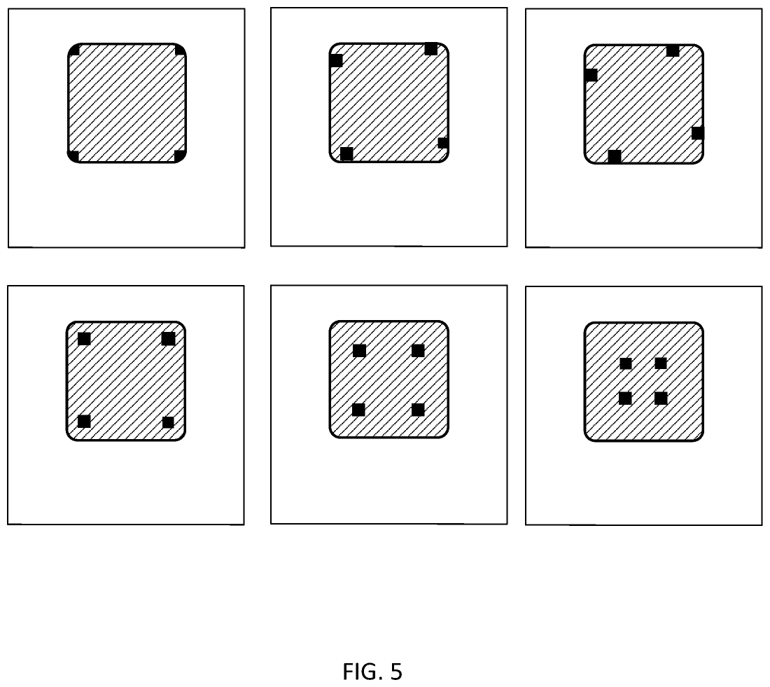

In the illustrative example of FIG. 4, only the subset represented by pixels 404, shown, are actuated during a single pulse sequence applied to keep the droplet in place. In the following pulse sequence, a different subset of pixels is actuated. As illustrated in FIG. 5, a different subset is again selected for each subsequent pulse of the pattern, until all of the unactuated pixel subsets have been driven. In the instance of the 10×10 pixel droplet of FIG. 4, this would allow for up to 25 subsets of 4 pixels that are symmetrically distributed about the center of the area under the droplet. This in turn would reduce the actuated time for each pixel by a factor of 25 and, as such, lead to a 25-fold increase in the longevity of pixels that are actuated in the course of holding patterns.

Returning to FIG. 5, it can be seen that only a fraction of the pixels under the area of the droplet are actuated during any single pulse sequence. The actuated pixels, shown in red, cycle through all of the undriven pixels, in symmetrical combinations, until each pixel has been driven. The subsets of FIG. 5, shown for illustration, cycle under the droplet followed by incrementally moving, one pixel at the time, toward the center of the droplet in new symmetric cycle patterns that hold the drop in place and prevent unwanted drifting. It can be seen that each subset of the pixels may include none of the pixels of the subsets actuated by the previous and subsequent pulse sequences.

This approach may be implemented with any number of intermittent driving patterns driving pixel subsets of different sizes. Patterns actuating 2 or 3 pixels at a time may be cycled through with varying degrees of symmetry and ability to hold the droplet in place, the limit being a single pixel at the center point of the area under the droplet. However, the actuation of too few pixels may in some instances lead the drop to change shape and the center of mass of the droplet to be displaced from the geometric center of the pixels under the droplet surface. The higher the resolution of the DMF pixel array relative to the size of the droplets in the microfluidic space, the higher the potential advantages to be had from pixel subset actuation. As a result, increasing the pixel resolution of a DMF device combined with using intermittent pixel subset addressing would reduce or eliminate the wear and damage caused by long term actuation. In one non-limiting embodiment, the resolution of the device is maintained sufficiently high to have droplets covering an area of at least 3×3 pixels, so as to increase the lifetime of the device.

Since the force of actuation on the drop is realized at the edges of the drop, the actuation of the subpixels close to the edges of the droplet will hold the drop most closely to the same position. However, if the pattern is attempting to hold a drop at the very edge of the drop and the drop has already drifted at all the hold actuation might miss the drop edge all together with a very small drift movement. This means there is a risk to holding patterns utilizing a static pattern only at the very extreme corners of the pattern as well. If only the sets of pixels more to the interior of the droplet are actuated, it is possible the droplet may drift until one of those actuated pixels is at the edge of the droplet. If the actuated droplets are always chosen symmetric around the center of the original droplet location then that would mean the most the droplet can drift will always be less than half of a droplet diameter, even if it drifts to the edge for the narrowest set subpixel configurations.

To keep the drop from drifting, keep all the pixels with the same electrical duty cycle, and use all the subpixels to maximize the intermittency effect, it would be beneficial to design the pattern of switching such that if you are going to use the subpixels closer to the center of the droplet, then use pixels closer to the edge for the next set to correct any small drift that may occur from using a set close to the interior. The intermediate sets of pixels then would create the best balance of providing some small distance from the edge of the drop so that a pattern will not miss the drop due to a tiny drift and also keeping the droplet in place to less than half a drop diameter.

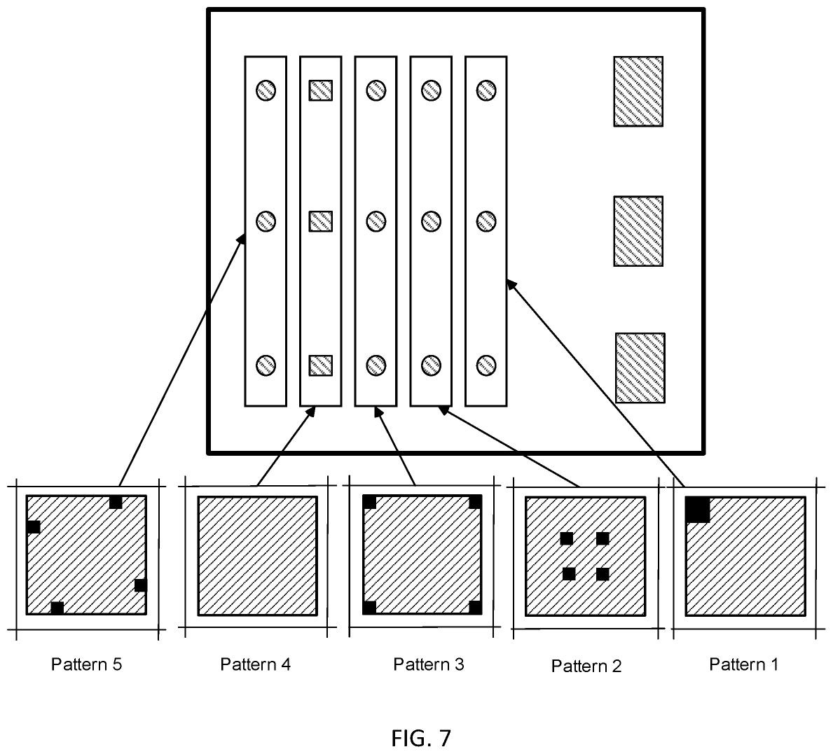

As illustrated in FIG. 7, the experiment is shown to have created multiple of the patterns described including a static pattern at the very outside corners of the drop pattern 3. It seems like for one of the 3 drops, the pattern lost the drop and allowed it to drift some. Using the outer edge but moving which pixels constantly was also tried which should be less likely to lose the pattern with the changing actuation location was also used for pattern 5. This pattern seemed to keep the drop within the half diameter of the original drop and would not lose the pattern. Pattern 2 is an intermediate pattern symmetric around the center but away from the edge so there is little chance of losing the pattern from a small drift of the droplet. This seems to hold the droplet quite well relative to the original position with only 4 of the 100 pixels actuated. There was also 1 pattern that was not symmetric around the center and for pattern 1 was arranged in the upper left corner. All of those drops drifted up and out of the original location and were not able to be held well by that pattern.

| | |
|---|---|
| Pattern 1 | All in upper left, no center symmetry |
| Pattern 2 | Static actuation, symmetry around |
| | center, intermediate spacing |
| Pattern 3 | Static actuation, symmetry around |
| | center, fully at the edge of drop |
| Pattern 4 | All pixels constantly actuated |
| Pattern 5 | Constant motion of pixels around the |
| | edge, symmetric around center |

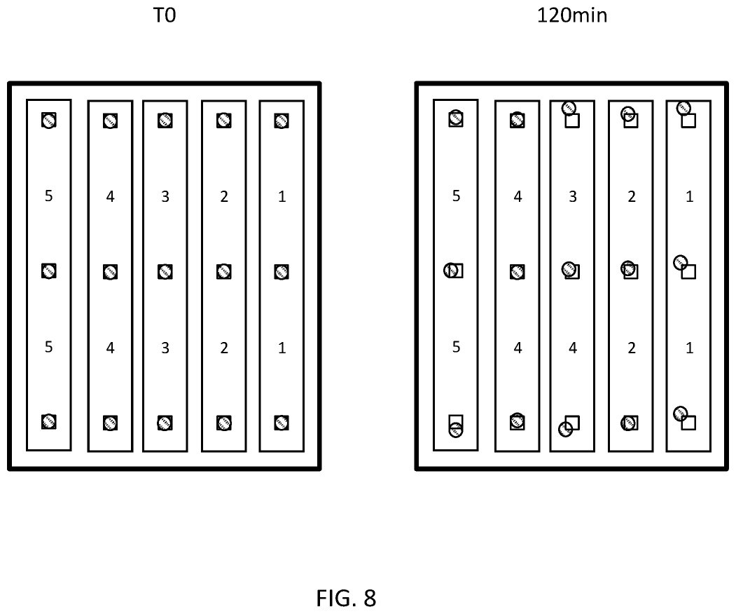

Symmetry around the center of the drop seems to be of high importance and also not trying to hit the extreme edge of the drop with a static pixel location because if the drop relaxes or drifts a tiny amount causing accuracy then you lose the drop and the pattern is then slightly outside of the drop on one edge and allows it to drift. In FIG. 8, it can be seen that using the subpixels can hold the drop in place but it is beneficial to keep them spaced with symmetry around the center of the drop or close to it and intermediate distance from the edge to keep from losing the pattern. In order to maximize the number of patterns that can be used the extreme center and edges could be used but should be mixed in the sequence surrounded by intermediate distances to avoid losing the pattern which can happen with repeated actuation at only a few pixels at the extreme edges of the drop. Often, holding forces applied to hold a droplet in a desired location in a DMF need not be as strong as those usually required for other types of droplet manipulation such as transporting a droplet from one location to another. Consequently, intermittent pixel driving patterns may actuate pixels at lower voltages than those associated with other steps of a droplet operation. By way of example, if a droplet operation, for example a bioassay, involves loading, dispensing, merging, and splitting droplets by actuating the pixels at a set operating voltage, the applied intermittent driving patterns may include pulses at potentials lower than the above operating voltage.

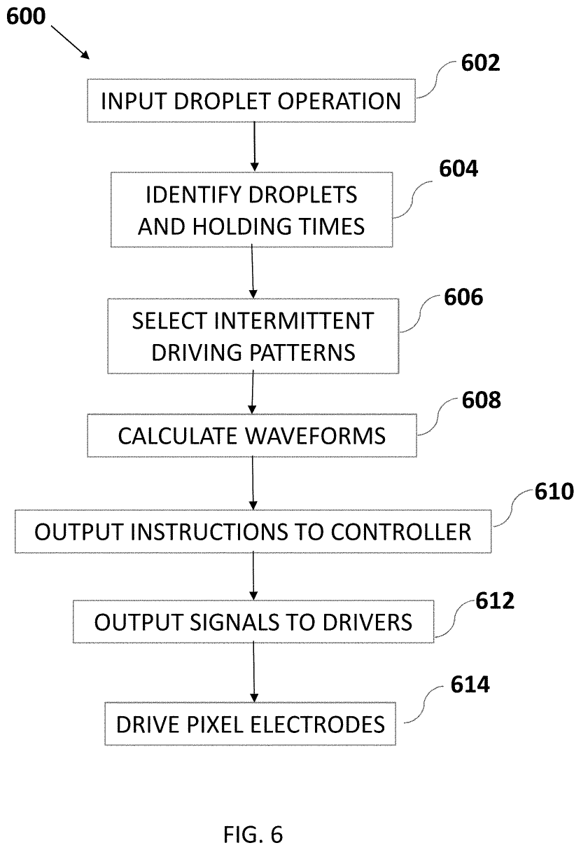

The flow chart of FIG. 6 illustrates an example process 600 for holding a droplet in place whereby intermittent pixel driving patterns are calculated, selected, and implemented on the basis of parameters such as the size, composition, reagent concentration, salt and buffer concentration, surface tension, holding time, and other characteristics of the droplet and its environment within the device. In step 602, a user inputs the droplet operation they wish to perform in the form of instructions which are stored in a computer-readable medium that is accessed by the processing unit of a DMF device. The user may also input other relevant variables affecting the choice of intermittent driving pattern, such as the composition, viscosity, temperature, and surface tension of the fluids taking part in the droplet operation.

The instructions cause the processing unit to execute an algorithm stored in a computer-readable medium and identify droplets that will require holding in place and their respective holding times at each point in the course of the droplet operation (604). For each droplet that is to be held in place, the processing unit selects a suitable intermittent driving pattern (606) from among a number of available intermittent driving patterns. Parameters guiding this selection may include any of the variables outlined above. The voltages applied in the course of intermittent driving patterns may be lower than the driving potentials associated with the other manipulations of the droplet operation.

The patterns may be specifically tailored to droplets having different characteristics and may be stored in a non-transitory, computer readable storage medium accessible to the processing unit. Exemplary media include memory storage banks within the device itself and cloud databases accessible to the processing unit on demand.

Then, as the droplet operation is carried out, the processing unit executes intermittent driving patterns in instances where active holding in place is required or preferred. The processing unit generates images corresponding to intermittent driving patterns and the polarity, frequency, and amplitude of each of the pulses of the corresponding waveforms are calculated (608). Then, the processing unit outputs electrode actuation instructions to a controller (610), and the controller outputs signals to the drivers (612) which in turn drive the pixel electrodes (614). In instances where the bottom plate includes an array of TFT electrodes, the controller outputs gate line signals to the drivers of gate lines and data line signals to data line drivers, thereby actuating the intended pixel electrodes. The selected pixel electrodes are then driven to perform the intermittent driving pattern holding the drop in place.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. A method for holding an aqueous droplet in a selected location within a microfluidic device, wherein the microfluidic device comprises:
a top plate comprising a top substrate, a first layer of hydrophobic material applied to a surface of the top substrate, and a common top electrode between the first layer of hydrophobic material and the top substrate;
a bottom plate comprising a pixel array, the pixel array comprising a plurality of pixel electrodes and a second layer of hydrophobic material applied over the plurality of pixel electrodes; and
a microfluidic gap between the first and second layers of hydrophobic material;
the method comprising applying an intermittent driving pattern to pixels under the area of the droplet, wherein the intermittent driving pattern comprises, in order:
actuating a first subset of the pixels under the area of the droplet, and
actuating a second subset of the pixels under the area of the droplet.

2. The method according to claim 1, wherein the second subset includes at least one pixel not belonging to the first subset.

3. The method according to claim 2, wherein the second subset includes no pixels belonging to the first subset.

4. The method according to claim 1, wherein the first and second subsets are symmetrically distributed about the center point of the selected location.

5. The method according to claim 4, wherein the center of the first subset and the center of the second subset overlap the center point of the selected location.

6. The method according to claim 1, wherein the intermittent driving pattern further comprises actuating a third subset of the pixels under the area of the droplet.

7. The method according to claim 6, wherein the third subset includes at least one pixel not belonging to the first subset or second subset.

8. The method according to claim 7, wherein the third subset includes no pixels belonging to the first subset and second subset.

9. The method according to claim 8, wherein the pixel array is configured with at least 500×500 pixel electrodes.

10. The method according to claim 9, wherein the droplet covers at least 10×10 pixel electrodes.

11. The method according to claim 10, wherein the at least 10×10 pixel electrodes are split into subsets of 4 pixels that are symmetrically distributed about the center of the area under the droplet.

12. A digital microfluidic device, comprising:
a top plate comprising a top substrate, a first layer of hydrophobic material applied to a surface of the top substrate, and a common top electrode between the first layer of hydrophobic material and the top substrate;
a bottom plate comprising a pixel array, the pixel array comprising a plurality of pixel electrodes and a second layer of hydrophobic material applied over the plurality of pixel electrodes,
a processing unit operably programmed to perform a microfluidic driving method; and
a controller operatively coupled to the processing unit, common top electrode, and a bottom plate pixel array, wherein the controller is configured to provide actuation voltages between the common top electrode and the pixel electrodes;
wherein the processing unit is operably programmed to:
receive input instructions, the input instructions relating to a droplet operation;
select an intermittent driving pattern for holding in place a droplet of the droplet operation, wherein the intermittent driving pattern comprises, in order:
actuating a first subset of pixels under the area of the droplet, and
actuating a second subset of the pixels under the area of the droplet; and
output electrode actuation instructions to the controller, the electrode actuation instructions relating to a driving sequence for implementing the intermittent driving pattern, to hold the droplet in a selected location.

13. The digital microfluidic system according to claim 12, wherein the processing unit is operably programmed to identify at least one droplet requiring holding in place in the course of the droplet operation.

14. The digital microfluidic system according to claim 12, wherein the intermittent driving pattern is selected on the basis of a parameter selected from the group consisting of droplet size, droplet composition, droplet holding time, droplet viscosity, droplet temperature, droplet surface tension, and combinations thereof.

15. The digital microfluidic system according to claim 12, wherein the second subset includes at least one pixel not belonging to the first subset.

16. The digital microfluidic system according to claim 12, wherein the second subset includes no pixels belonging to the first subset.

17. The digital microfluidic system according to claim 12, wherein the first and second subsets are symmetrically distributed about the center point of the selected location.

18. The digital microfluidic system according to claim 12, wherein the center of the first subset and the center of the second pixel subset overlap the center point of the selected location.

19. The digital microfluidic system according to claim 18, wherein the intermittent driving pattern further comprises actuating a third subset of the pixels under the area of the droplet.

20. The digital microfluidic system according to claim 19, wherein the third subset includes at least one pixel not belonging to the first subset or second subset.
